(19) United States
(12) Patent Application Publication
(10) Pub. No.: US 2025/0326536 A1
(43) Pub. Date: Oct. 23, 2025

(54) FLY SWATTER STORAGE DEVICE

(71) Applicant: THOMAS ANTHONY MARCANTONIO, WELLAND (CA)

(72) Inventor: THOMAS ANTHONY MARCANTONIO, WELLAND (CA)

(21) Appl. No.: 18/642,960

(22) Filed: Apr. 23, 2024

(51) Int. Cl. B65D 43/16; A01M 3/02; B65D 1/34; B65D 25/10; B65D 25/22; B65D 43/22

(52) U.S. Cl. CPC B65D 43/167; A01M 3/02; B65D 1/34; B65D 25/10; B65D 25/22; B65D 43/22; B65D 2251/1058; B65D 2543/00194

(57) ABSTRACT

The fly swatter storage device includes a pan structure, a door structure, a latch structure, and a fly swatter. The fly swatter forms the tool of the fly swatter storage device. The door structure attaches to the pan structure to form a protected space. The protected space contains the fly swatter when the fly swatter is not in use. The door structure attaches to the pan structure such that the door structure rotates relative to the pan structure between a closed position and an open position. The latch structure secures the door structure in the closed position. The fly swatter exchanges momentum with the insect such that the insect is placed in a state of reduced consciousness.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of fly swatters. (A01M3/02)

### SUMMARY OF INVENTION

The fly swatter storage device comprises a pan structure, a door structure, a latch structure, and a fly swatter. The fly swatter forms the tool of the fly swatter storage device. The door structure attaches to the pan structure to form a protected space. The protected space contains the fly swatter when the fly swatter is not in use. The door structure attaches to the pan structure such that the door structure rotates relative to the pan structure between a closed position and an open position. The latch structure secures the door structure in the closed position. The fly swatter exchanges momentum with the insect such that the insect is placed in a state of reduced consciousness.

These together with additional objects, features and advantages of the fly swatter storage device will be readily apparent to those of ordinary skill in the art upon reading the following detailed description of the presently preferred, but nonetheless illustrative, embodiments when taken in conjunction with the accompanying drawings.

In this respect, before explaining the current embodiments of the fly swatter storage device in detail, it is to be understood that the fly swatter storage device is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the fly swatter storage device.

It is therefore important that the claims be regarded as including such equivalent construction insofar as they do not depart from the spirit and scope of the fly swatter storage device. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a perspective view of an embodiment of the disclosure.

FIG. 3 is a front view of an embodiment of the disclosure.

FIG. 4 is a rear view of an embodiment of the disclosure.

FIG. 5 is a side view of an embodiment of the disclosure.

FIG. 6 is a front view of an alternate embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

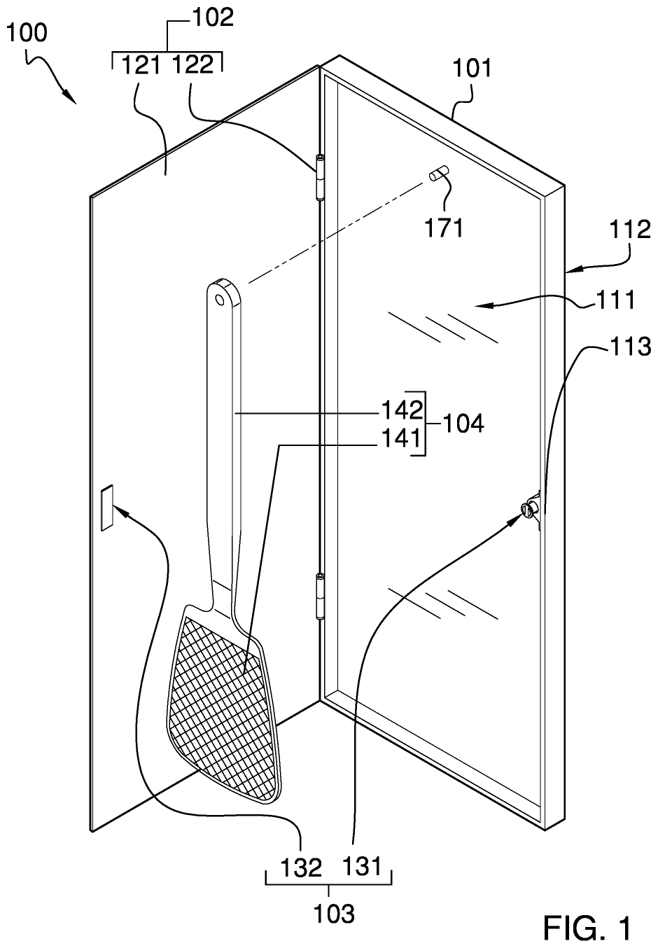

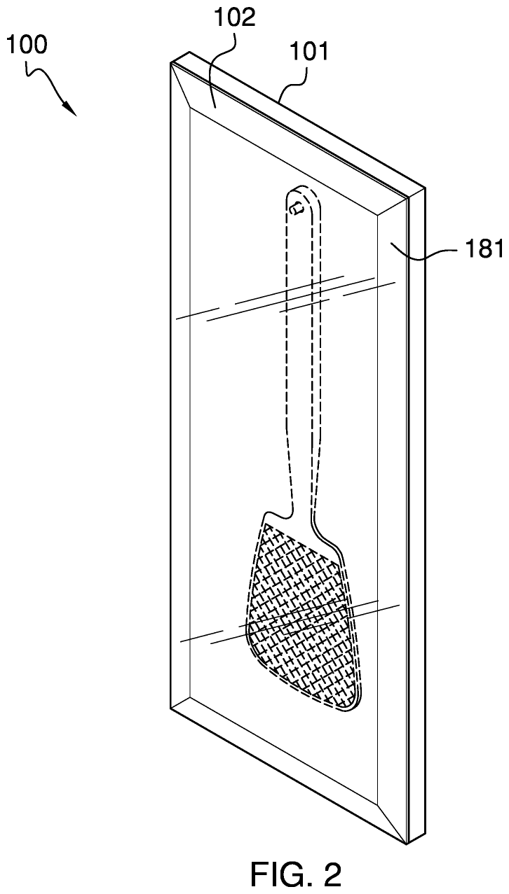

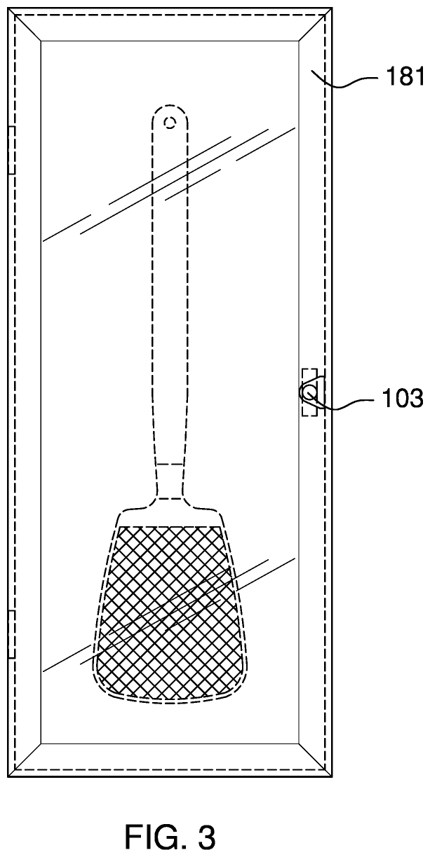

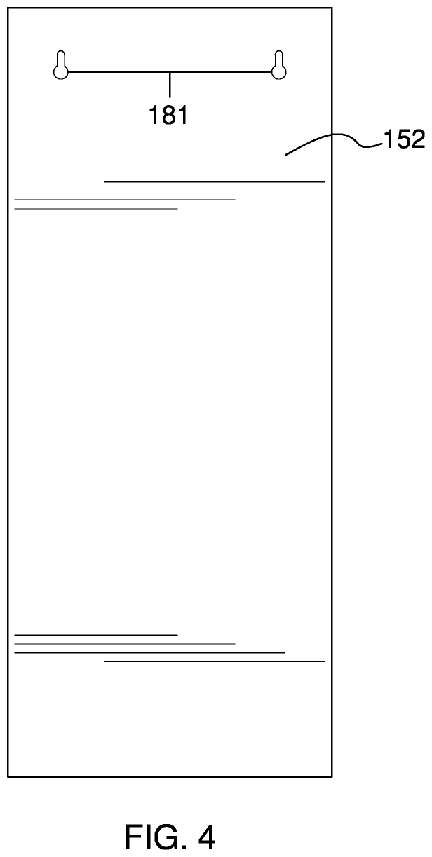

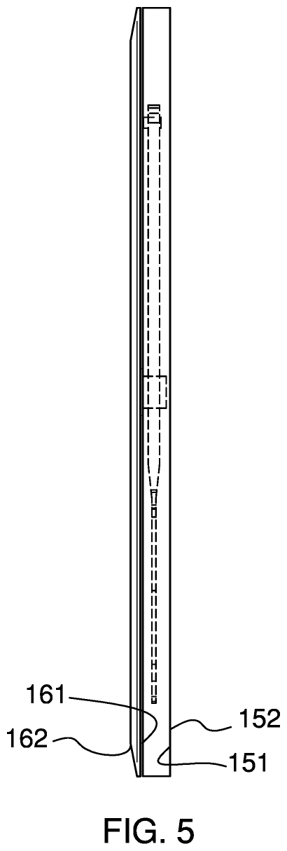

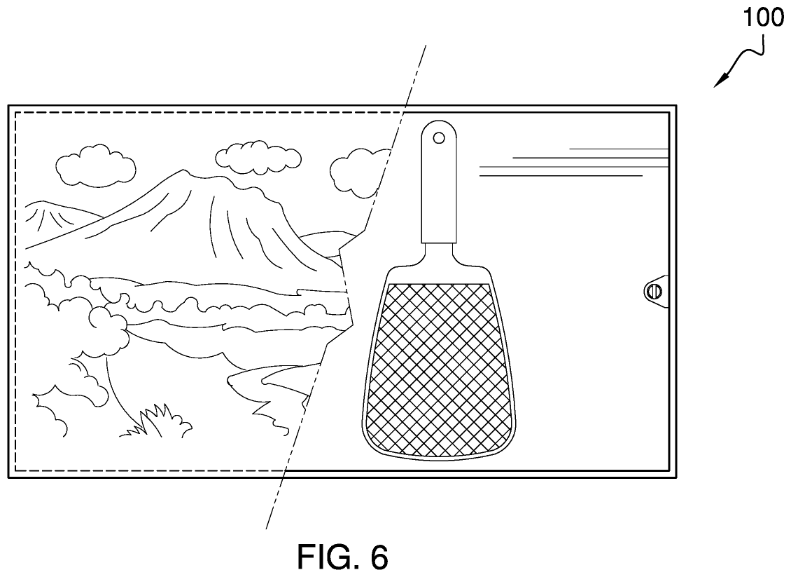

Detailed reference will now be made to one or more potential embodiments of the disclosure, which are illustrated in FIGS. 1 through 6.

The fly swatter storage device 100 (hereinafter invention) is a tool. The invention 100 is a momentum transfer device. The invention 100 is adapted for use with an insect. The invention 100 exchanges momentum with the insect such that the insect is placed in a state of reduced consciousness. The invention 100 comprises a pan structure 101, a door structure 102, a latch structure 103, and a fly swatter 104. The fly swatter 104 forms the tool of the invention 100. The door structure 102 attaches to the pan structure 101 to form a protected space. The protected space contains the fly swatter 104 when the fly swatter 104 is not in use. The door structure 102 attaches to the pan structure 101 such that the door structure 102 rotates relative to the pan structure 101 between a closed position and an open position. The latch structure 103 secures the door structure 102 in the closed position.

The fly swatter 104 forms the tool of the invention 100. The fly swatter 104 is a handheld device. The fly swatter 104 forms a striking tool that is used to strike an insect. The fly swatter 104 strikes the insect with enough velocity such that the momentum fly swatter 104 transferred from the fly swatter 104 to the insect is adequate to reduce the consciousness of the insect. The fly swatter 104 comprises a working element 141 and a handle structure 142.

The working element 141 is a disk shaped structure. The working element 141 is a flexible structure. The working element 141 forms the structure of the fly swatter 104 that strikes the insect. The working element 141 attaches to the handle structure 142.

The handle structure 142 is a grip. The handle structure 142 attaches to the working element 141. The handle structure 142 is used to carry, move, and manipulate the working element 141. The handle structure 142 attaches the fly swatter 104 to the hook structure 171 mounted on the interior cf surface 151 of the pan structure 101.

The pan structure 101 is a prism shaped structure. The pan structure 101 is a hollow structure. The pan structure 101 is formed in a pan shape. The pan structure 101 forms a protected space. The pan structure 101 is sized such that the fly swatter 104 fits within the protected space formed by the pan structure 101. The pan structure 101 comprises an open face 111, a closed face 112, and a plurality of lateral faces 113.

The closed face 112 forms the closed face 112 of the pan structure of the pan structure 101. The closed face 112 forms the solid face of the pan structure 101 with the greatest surface. The closed face 112 comprises an interior cf surface 151 and an exterior cf surface 152.

The interior cf surface 151 forms a congruent end of the disk structure of the closed face 112 of the pan structure 101. The interior cf surface 151 is the surface of the closed face 112 that is proximal to the open face 111 of the pan structure 101. The interior cf surface 151 further comprises a hook structure 171. The hook structure 171 is a hook that attaches to the interior cf surface 151 of the closed face 112 of the pan structure 101. The hook structure 171 forms the structure that suspends the fly swatter 104 within the protected space formed by the pan structure 101.

The exterior cf surface 152 forms a congruent end of the disk structure of the closed face 112 of the pan structure 101. The exterior cf surface 152 is the surface of the closed face 112 that is distal from the interior cf surface 151. The exterior cf surface 152 is the surface of the disk structure of the closed face 112 with the greatest surface. The exterior cf surface 152 forms a portion of the exterior surface of the pan structure 101. The exterior cf surface 152 further comprises a plurality of keyhole structures 172. The plurality of keyhole structures 172 are formed in the exterior dp surface 162 of the closed face 112 of the pan structure 101. The plurality of keyhole structures 172 forms a mechanical structure used to hang the invention 100 from a vertically oriented surface.

The open face 111 forms the open face 111 of the pan structure of the pan structure 101. The open face 111 is the face of the pan structure 101 that is distal from the closed face 112. The open face 111 is the face of the pan structure 101 that provides access into the protected space formed by the pan structure 101. The fly swatter 104 is placed into and removed from the pan structure 101 through the open face 111.

The plurality of lateral faces 113 forms the lateral face structure of the pan shape of the pan structure 101. The plurality of lateral faces 113 attach to and project away from the interior cf surface 151 of the closed face 112 of the pan structure 101. The plurality of lateral faces 113 forms a portion of the boundary structures that enclose the protected space formed by the pan structure 101. The plurality of lateral faces 113 forms the structure that bridges the reach between the closed face 112 and the open face 111 of the pan shape of the pan structure 101.

The door structure 102 is a disk shaped structure. The door structure 102 is a solid structure. The door structure 102 attaches to the pan structure 101. The door structure 102 rotates between a closed position and an open position. The door structure 102 is geometrically similar to the open face 111 of the pan structure 101. The door structure 102 is sized such that the door structure 102 encloses the open face 111 when the door structure 102 rotates into the closed position. The door structure 102 prevents access into the hollow interior of the pan structure 101 in the closed position. The door structure 102 allows access into the hollow interior of the pan structure 101 in the open position. The door structure 102 comprises a door plate 121 and a door hinge 122.

The door plate 121 is a rigid structure. The door plate 121 forms the primary shape of the door structure 102. The door plate 121 is a disk shaped structure. The door plate 121 is geometrically similar to the open face 111 of the pan structure 101. The door plate 121 forms the physical structure that rotates between the open position and the closed position. The door plate 121 forms the structure that encloses the open face 111 in the closed position. The door plate 121 comprises an interior dp surface 161 and an exterior dp surface 162.

The interior dp surface 161 forms a congruent end of the disk structure of the door plate 121 of the pan structure 101. The interior dp surface 161 is the surface of the door plate 121 that is proximal to the closed face 112 of the pan structure 101.

The exterior dp surface 162 forms a congruent end of the disk structure of the door plate 121 of the door structure 102. The exterior dp surface 162 is the surface of the door plate 121 that is distal from the interior dp surface 161. The exterior dp surface 162 is the surface of the disk structure of the door plate 121 with the greatest surface. The exterior dp surface 162 forms a portion of the exterior surface of the door structure 102. The exterior dp surface 162 further comprises an image frame 181.

The image frame 181 is a mechanical structure. The image frame 181 mounts on the exterior dp surface 162 of the door plate 121 of the door structure 102. The image frame 181 forms a structure that receives a sheeting structure. The sheeting structure inserts into the image frame 181 such that any image formed on the sheeting structure is visible from the exterior of the invention 100.

The door hinge 122 is a hinge. The door hinge 122 attaches the door plate 121 to a lateral face selected from the plurality of lateral faces 113 of the pan structure 101. The door hinge 122 attaches the door plate 121 to the pan structure 101 such that the door structure 102 rotates relative to the pan structure 101.

The latch structure 103 is a mechanical structure. The latch structure 103 is a fastening device. The latch structure 103 forms a latch that releasably secures the door structure 102 to the pan structure 101 when the door structure 102 rotates into the closed position. The latch structure 103 comprises a latch anchor 131 and a latch arm 132.

The latch anchor 131 is a mechanical substructure of the latch structure 103. The latch anchor 131 attaches to the interior lip of a lateral face selected from the plurality of lateral faces 113 of the pan structure 101. The latch anchor 131 forms an anchor point that the latch arm 132 detachably attaches to.

The latch arm 132 is a mechanical substructure of the latch structure 103. The latch arm 132 attaches to the interior lip of a lateral face selected from the interior dp surface 161 of the door structure 102. The latch arm 132 forms a latching mechanism that latch arm 132 detachably attaches to the latch anchor 131. The latch arm 132 secures the door structure 102 to the pan structure 101 in the closed position.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Anchor: As used in this disclosure, anchor means to hold an object firmly or securely.

Anchor Point: As used in this disclosure, an anchor point is a location to which a first object can be securely attached to a second object.

Barrier: As used in this disclosure, a barrier is a physical obstacle that forms a boundary between a first space and a second space. The barrier prevents the passage of an object between the first space and the second space.

Bridge: As used in this disclosure, a bridge refers to a load bearing structure that attaches a first object and to a second object such that a load bearing path is formed between the first object and the second object. The verb “to bridge” means to establish a connection (or remove a disconnection) between a first object and a second object.

Cant: As used in this disclosure, a cant is an angular deviation from one or more reference lines (or planes) such as a vertical line (or plane) or a horizontal line (or plane).

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Closed Position: As used in this disclosure, a closed position refers to a movable barrier structure that is in an orientation that prevents access into a protected space. The closed position is often referred to as an object being “closed.”

Composite Prism: As used in this disclosure, a composite prism refers to a structure that is formed from a plurality of structures selected from the group consisting of a prism structure, a pyramid structure, and a spherical structure. The plurality of selected structures may or may not be truncated or bifurcated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Consciousness: As used in this disclosure, consciousness refers to an emergent property derived from the synergy of multiple biochemical processes that are occurring simultaneously. By emergent property is meant that consciousness displays properties that are not inherent to the biochemical processes underlying consciousness. Examples of consciousness would include, but are not limited to, a body's awareness of its surrounding, a body's awareness of itself, an awareness that the body is perceiving their surroundings, the ability of a body to feel pain, and the inherent ability of a body to feel emotions. The term virtual consciousness means the incorporation of simulated emotional responses into a virtual biological organism for the purpose of generating a sentiment in a biological organism that the virtual biological organism is alive.

Correspond: As used in this disclosure, the term correspond is used as a comparison between two or more objects wherein one or more properties shared by the two or more objects match, agree, or align within acceptable manufacturing tolerances.

Decorative: As used in this disclosure, decorative is an adjective that refers to a first object or item that is used with a second object or item of the purpose of making the second object or item more interesting or attractive. Decorative will generally, but not necessarily, implies making the second object or item more visually attractive.

Diameter: As used in this disclosure, a diameter of an object is a straight line segment (or a radial line) that passes through the center (or center axis) of an object. The line segment of the diameter is terminated at the perimeter or boundary of the object through which the line segment of the diameter runs. A radius refers to the line segment that overlays a diameter with one termination at the center of the object. A span of a radius is always one half the span of the diameter.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Elevation: As used in this disclosure, elevation refers to the span of the distance in the superior direction between a specified horizontal surface and a reference horizontal surface. Unless the context of the disclosure suggest otherwise, the specified horizontal surface is the supporting surface the potential embodiment of the disclosure rests on. The infinitive form of elevation is to elevate.

Energy: As used in this disclosure, the energy is a term used in physics. Energy refers to the ability of a system to do work. Energy is a conserved property of a system. Energy is a quantifiable and is generally expressed in units of Joules.

Environment: As used in this disclosure, an environment refers to the physical conditions surrounding an object. The term environment is often limited to the physical conditions that the object interacts with.

Extension Structure: As used in this disclosure, an extension structure is an inert physical structure that is used to extend or bridge the reach between any two objects.

Exterior: As used in this disclosure, the exterior is used as a relational term that implies that an object is not contained within the boundary of a structure or a space.

Force: As used in this disclosure, a force refers to a net (or unopposed) measurable interaction that changes the direction of motion of an object, the velocity of motion of an object, the momentum of an object, or the stress within an object. The term work refers to a measure of the amount of energy that is transferred through the application of a force over a distance. The term power refers to a measure of the amount of energy that is transferred over a period of time.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. By the term essentially geometrically similar is meant that the primary shapes of two objects are geometrically similar except that there are functional items (such as fastening devices) associated with the primary shape may not maintain the ratio for geometric similarity. By the term roughly geometrically similar is meant that the form factors between the primary shape of the two objects can vary by a factor of up to 10% when the two objects are normalized to be roughly geometrically identical.

Grip: As used in this disclosure, a grip is an accommodation formed on or within an object that allows the object to be grasped or manipulated by a hand.

Ground: As used in this disclosure, the ground is a solid supporting surface formed by the Earth. The term level ground means that the supporting surface formed by the ground is roughly perpendicular to the force of gravity. The term underground refers to an object being underneath the superior surface of the ground.

Handle: As used in this disclosure, a handle is an object by which a tool, object, or door is held or manipulated with the hand.

Hinge: As used in this disclosure, a hinge is a device that permits the turning, rotating, or pivoting of a first object relative to a second object. A hinge designed to be fixed into a set position after rotation is called a locking hinge. A spring loaded hinge is a hinge formed as an elastic structure. The elastic structure of the spring loaded hinge is deformed under a rotating force such that the elastic structure returns the spring loaded hinge back to its relaxed shape after the rotating force is removed from the spring loaded hinge.

Hinge: As used in this disclosure, a hinge is a device that permits the turning, rotating, or pivoting of a first object relative to a second object. A hinge designed to be fixed into a set position after rotation is called a locking hinge. A spring loaded hinge is a hinge formed as an elastic structure. The elastic structure of the spring loaded hinge is deformed under a rotating force such that the elastic structure returns the spring loaded hinge back to its relaxed shape after the rotating force is removed from the spring loaded hinge.

Hook: As used in this disclosure, a hook is an object that is curved or bent at an angle such that items can be hung on or caught by the object.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Housing: As used in this disclosure, a housing is a rigid structure that encloses and protects one or more devices.

Impact: As used in this disclosure, an impact refers to an exchange of momentum between two objects over a duration. An impact often refers to a collision between two objects.

Inferior: As used in this disclosure, the term inferior refers to a directional reference that is parallel to and in the same direction as the force of gravity when an object is positioned or used normally.

Inner Diameter: As used in this disclosure, the term inner diameter is used in the same way that a plumber would refer to the inner diameter of a pipe.

Insect: As used in this disclosure, an insect refers to an animal that is: a) small relative to humans; b) cold-blooded; and, c) an invertebrate. An insect can often be identified through a combination of the following additional anatomical features: d) an exoskeleton; e) wings; f) a segmented body structure (head, thorax, and abdomen); and, g) having more than four legs.

Interior: As used in this disclosure, the interior is used as a relational term that implies that an object is contained within the boundary of a structure or a space.

Keyhole: As used in this disclosure, a keyhole refers to a negative space formed through a surface. The keyhole has a characteristic shape of a rectangle with a circle located at the narrow end of the rectangle. The diameter of the circle is greater than the span of the narrow end of the rectangle. The keyhole is used to secure an object to the surface. Specifically, the object has a disk shape mounted on an extension structure. The diameter of the disk is less than the diameter of the circle such that the disk will insert through the circle. The diameter of the disk is greater than the span of the narrow end of the rectangle such when the disk is slid underneath the rectangle the disk will not pass through the rectangle thereby securing the object to the surface. The size of the extension structure is selected such that the extension will slide into the rectangle. Use diameter, extension structure, disk, and cylinder.

Latch: As used in this disclosure, a latch is a fastening or locking mechanism commonly used to secure a rotating structure into a closed position.

Lip: As used in this disclosure, a lip refers to the region of the lateral face of a pan or tube structure that abuts the perimeter of the open face of the pan or tube structure. By abutting the perimeter of the open face is meant that the lip forms a brink with the surface that forms the perimeter of the open face. The lip of the interior surface of the pan structure is called the interior lip. The lip of the exterior surface of the pan structure is called the exterior lip. The region of the lateral face of a pan structure that abuts the perimeter of the closed face of the pan structure is called the brink lip.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load Path: As used in this disclosure, a load path refers to a chain of one or more structures that transfers a load generated by a raised structure or object to a foundation, supporting surface, or the earth.

Momentum: As used in this disclosure, momentum is a measured quantity associated with the mass of a moving object. The momentum of the object equals the mass of the object multiplied by the velocity of the object. The exchange of momentum between two objects is a conserved quantity meaning that the sum of the momentums of the two objects before an exchange of momentum equals the sum of the momentums of the two objects after the exchange.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction. In a one to one correspondence, the first element of the first set is said to be associated to the second element of the second set to which the first element corresponds.

Open Position: As used in this disclosure, an open position refers to a movable barrier structure that is in an orientation that allows passage through a port or an aperture. The open position is often referred to as an object being “open.”

Orientation: As used in this disclosure, orientation refers to the positioning of a first object relative to: 1) a second object; or, 2) a fixed position, location, or direction.

Outer Diameter: As used in this disclosure, the term outer diameter is used in the same way that a plumber would refer to the outer diameter of a pipe.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan are open.

Perimeter: As used in this disclosure, a perimeter is one or more curved or straight lines that bounds an enclosed area on a plane or surface. The perimeter of a circle is commonly referred to as a circumference.

Primary Shape: As used in this disclosure, the primary shape refers to a description of the rough overall geometric shape of an object that is assembled from multiple components or surfaces. The term essential primary shape is used to indicate the exclusion of functional items that are attached to the structure of the primary shape.

Primary Structure: As used in this disclosure, a primary structure refers to the component of an object that the other components attach to. The primary structure is also called the base structure.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Protected Space: As used in this disclosure, a protected space is a negative space within which an object is stored. The protected space is enclosed by a barrier structure that: a) prevents damage to the object contained within the protected space; b) maintains conditions that are appropriate for the object; c) protects the object within the protected space from potential dangers that are outside of the protected space; or, d) maintains the privacy of the object within the protected space.

Radial: As used in this disclosure, the term radial refers to a direction that: 1) is perpendicular to an identified central axis; or, 2) projects away from a center point.

Reach: As used in this disclosure, reach refers to a span of distance between any two objects.

Striking Tool: As used in this disclosure, a striking tool is a tool that exchanges momentum in a controlled manner between two objects through an impact. A hammer is an example of a striking tool.

Superior: As used in this disclosure, the term superior refers to a directional reference that is parallel to and in the opposite direction of the force of gravity when an object is positioned or used normally.

Supporting Surface: As used in this disclosure, a supporting surface is a horizontal surface upon which an object is placed and to which the load of the object is transferred. This disclosure assumes that an object placed on the supporting surface is in an orientation that is appropriate for the normal or anticipated use of the object.

Suspend: As used in this disclosure, to suspend an object means to support an object such that the inferior end of the object does not form a significant portion of the load path of the object.

Tool: As used in this disclosure, a tool is a device, an apparatus, or an instrument that is used to carry out an activity, operation, or procedure. A tool generally comprises a working element and a handle. The handle of a tool that forms a sub-component of a larger structure is referred to as a mount.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

Working Element: As used in this disclosure, the working element of a tool is the physical element on the tool that performs the actual activity, operation, or procedure the tool is designed to perform. For example, the cutting edge of a blade is the working element of a knife.

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

1. A fly swatter storage device comprising
a pan structure, a door structure, a latch structure, and a fly swatter;
wherein the fly swatter forms the tool of the fly swatter storage device;
wherein the door structure attaches to the pan structure to form a protected space;
wherein the protected space contains the fly swatter;
wherein the door structure attaches to the pan structure such that the door structure rotates relative to the pan structure between a closed position and an open position;
wherein the latch structure secures the door structure in the closed position;
wherein the pan structure is sized such that the fly swatter fits within the protected space formed by the pan structure;
wherein the door structure is geometrically similar to an open face of the pan structure;
wherein the door structure is sized such that the door structure encloses the open face when the door structure rotates into the closed position;
wherein the door structure prevents access into a hollow interior of the pan structure in the closed position;
wherein the door structure allows access into the hollow interior of the pan structure in the open position.

2. The fly swatter storage device according to claim 1
wherein the fly swatter exchanges momentum to generate a state of reduced consciousness;
wherein the fly swatter is a handheld device;
wherein the fly swatter comprises a working element and a handle structure;
wherein the working element is a disk shaped structure;
wherein the working element is a flexible structure;
wherein the working element forms the structure of the fly swatter that transfers the momentum;
wherein the working element attaches to the handle structure;
wherein the handle structure is a grip;
wherein the handle structure attaches to the working element.

3. The fly swatter storage device according to claim 2
wherein the pan structure is a prism shaped structure;
wherein the pan structure is a hollow structure;
wherein the pan structure is formed in a pan shape;
wherein the pan structure forms the protected space.

4. The fly swatter storage device according to claim 3 wherein the door structure is a solid structure.

5. The fly swatter storage device according to claim 4
wherein the latch structure is a mechanical structure;
wherein the latch structure is a fastening device;
wherein the latch structure forms a latch that releasably secures the door structure to the pan structure when the door structure rotates into the closed position.

6. The fly swatter storage device according to claim 5
wherein the pan structure comprises an open face, a closed face, and a plurality of lateral faces;
wherein the closed face forms the closed face of the pan structure of the pan structure;
wherein the closed face forms the solid face of the pan structure with a greatest surface;
wherein the open face forms the open face of the pan structure of the pan structure;
wherein the open face is the face of the pan structure that is distal from the closed face;
wherein the open face is the face of the pan structure that provides access into the protected space formed by the pan structure;
wherein the fly swatter is placed into and removed from the pan structure through the open face;
wherein the plurality of lateral faces forms the lateral face structure of the pan shape of the pan structure;
wherein the plurality of lateral faces attach to and project away from the interior cf surface of the closed face of the pan structure;
wherein the plurality of lateral faces forms a portion of a boundary structures that enclose the protected space formed by the pan structure;
wherein the plurality of lateral faces forms the structure that bridges the reach between the closed face and the open face of the pan shape of the pan structure.

7. The fly swatter storage device according to claim 6
wherein the door structure comprises a door plate and a door hinge;
wherein the door plate is a rigid structure;
wherein the door plate forms the primary shape of the door structure;
wherein the door plate is geometrically similar to the open face of the pan structure;
wherein the door plate forms the physical structure that rotates between the open position and the closed position;
wherein the door plate forms the structure that encloses the open face in the closed position;
wherein the door hinge is a hinge;
wherein the door hinge attaches the door plate to a lateral face selected from the plurality of lateral faces of the pan structure;
wherein the door hinge attaches the door plate to the pan structure such that the door structure rotates relative to the pan structure.

8. The fly swatter storage device according to claim 7
wherein the latch structure comprises a latch anchor and a latch arm;
wherein the latch anchor is a mechanical substructure of the latch structure;
wherein the latch anchor attaches to the interior lip of a lateral face selected from the plurality of lateral faces of the pan structure;
wherein the latch anchor forms an anchor point that the latch arm detachably attaches to;
wherein the latch arm is a mechanical substructure of the latch structure;
wherein the latch arm attaches to an interior lip of a lateral face selected from an interior door plate surface (hereinafter interior dp surface) of the door structure;
wherein the latch arm forms a latching mechanism that latch arm detachably attaches to the latch anchor;
wherein the latch arm secures the door structure to the pan structure in the closed position.

9. The fly swatter storage device according to claim 8
wherein the closed face comprises an interior closed face surface (hereinafter interior cf surface) and an exterior closed face surface (hereinafter exterior cf surface);
wherein the interior cf surface forms a congruent end of the disk structure of the closed face of the pan structure;
wherein the interior cf surface is the surface of the closed face that is proximal to the open face of the pan structure;
wherein the interior cf surface further comprises a hook structure;
wherein the hook structure is a hook that attaches to the interior cf surface of the closed face of the pan structure;
wherein the hook structure forms the structure that suspends the fly swatter within the protected space formed by the pan structure;
wherein the exterior cf surface forms a congruent end of the disk structure of the closed face of the pan structure;
wherein the exterior cf surface is the surface of the closed face that is distal from the interior cf surface;
wherein the exterior cf surface is the surface of the disk structure of the closed face with the greatest surface;
wherein the exterior cf surface forms a portion of the exterior surface of the pan structure.

10. The fly swatter storage device according to claim 9
wherein the door plate comprises an interior door plate surface (hereinafter interior dp surface) and an exterior door plate surface (hereinafter exterior dp surface);
wherein the interior dp surface forms a congruent end of the disk structure of the door plate of the pan structure;
wherein the interior dp surface is the surface of the door plate that is proximal to the closed face of the pan structure;
wherein the exterior dp surface forms a congruent end of the disk structure of the door plate of the door structure;
wherein the exterior dp surface is the surface of the door plate that is distal from the interior dp surface;
wherein the exterior dp surface is the surface of the disk structure of the door plate with the greatest surface;
wherein the exterior dp surface forms a portion of the exterior surface of the door structure.

11. The fly swatter storage device according to claim 10
wherein the exterior cf surface further comprises a plurality of keyhole structures;
wherein the plurality of keyhole structures are formed in the exterior dp surface of the closed face of the pan structure;
wherein the plurality of keyhole structures forms a mechanical structure used to hang the fly swatter storage device from a vertically oriented surface.

12. The fly swatter storage device according to claim 11
wherein the exterior dp surface further comprises an image frame;
wherein the image frame is a mechanical structure;
wherein the image frame mounts on the exterior dp surface of the door plate of the door structure;
wherein the image frame forms a structure that receives a sheeting structure;
wherein the sheeting structure inserts into the image frame such that any image formed on the sheeting structure is visible from the exterior of the fly swatter storage device.
